(19) United States
(12) Patent Application Publication
(10) Pub. No.: US 2005/0029760 A1
(43) Pub. Date: Feb. 10, 2005

(54) Reusable shopping cart play and protective system for children

(76) Inventor: Cynthia Lohman, Gaston, OR (US)

Correspondence Address: Robert J. Ireland, P.O. Box 273, Banks, OR, 97106, US

(21) Appl. No.: 10/634,601

(22) Filed: Aug. 4, 2003

(51) Int. Cl. B62D 39/00

(52) U.S. Cl. 280/33.992

(57) ABSTRACT

The present invention is a shopping cart child seat protection, organizer and play system allowing for the attachment of toys, bottles, and miscellaneous play things via lanyards and pockets while providing a protective cover over the upper frame rail of the fold out child seat found standard in most shopping carts. This alleviates danger and disruption in shopping with a small child who is likely to chew on the upper frame rail of the fold out child seat. The system is easily attached, and removably engagable via hook and loop connectors, being washable and reusable. The cloth construction of the system allows for easy storage in a purse, diaper bag, or pocket

### CROSS REFERENCE TO RELATED APPLICATIONS

### References Cited [Referenced By]

U.S. Patent Documents

| D328812 | August, 1992 | Pritchett. | |
|---|---|---|---|
| D357784 | April, 1995 | Ince. | |
| 3866649 | February, 1975 | Bringmann. | |
| 4805937 | February, 1989 | Boucher et al. | |
| 4881746 | November, 1989 | Andreesen | 280/33. |
| 4954384 | September, 1990 | Hartwell | 150/154. |
| 5215319 | June, 1993 | Farris. | |
| 5722672 | March, 1998 | Frederick | |
| 5312122 | May, 1994 | Doty. | |
| 5429377 | July, 1995 | Duer | 280/33. |

### STATEMENT REGARDING FED SPONSORED R&D

This research and development of this invention was not in any way sponsored by the Federal Government.

### BACKGROUND OF THE INVENTION

Small children accompany their parents to grocery stores, department stores and other public shopping locations. Shopping carts are present and available at these locations to help the shopper carry around selected items. It is common knowledge that when people shop at grocery, hardware or department stores, they will likely be using a shopping cart.

A parent who shops with a small child requires a safe convenient location to carry the child while selecting and transporting items for purchase. Although it is useful to have a place for the child to sit while shopping, the natural behavior of the child poses a problem. Young children as young as three months old are known to put their mouths on the fold out child seat frame rail.

Most shopping carts have what is commonly referred to as a fold out child seat in which the child sits facing the parent pushing the cart. The present invention removably engages with the upper frame rail of the fold out child seat directly in front of the child. Inherent problems with these public shopping carts are germs, chemicals, and filth associated with continuous contact with the general public without proper clean and disinfecting. This system covers a likely unsanitary contact point with a sanitary cloth covering providing protection and utility for the child and parent.

When the young child puts her mouth on the upper frame rail of the fold out child seat, the child is susceptible to chipping teeth on the metal bar, injuring her gums on the hard irregular surface, and ingesting germs, viruses, and filth. The proposed invention provides a layer of soft protection over the metal frame rail while providing a prophylactic to germs, viruses, and filth.

U.S. Pat. No. 5,215,319 allowed to Farris discloses several shopping cart handle cover embodiments. The embodiments include various materials attached in various ways around the shopping cart handle. The drawback with this embodiment is that it does not protect the child from the upper frame rail of the fold out child seat directly in front of the child and in continuously contacting the child.

Disclosed in the 1995 Fall catalog of Lillie's Kids, page 56, a product hangs from a shopping cart handle that has a pouch for storing snacks, a strap for carrying the device, and some toys that dangle therefrom. The problem with this product is that it only protects the child from the handle, not the upper frame rail of the fold out child seat. The upper frame rail of the fold out child seat is directly in front of the child, contacting the child's hands, mouth, and legs. This product fails to provide protection from the nearest threat, the upper frame rail of the child seat.

Another handle cover device is disclosed in U.S. Pat. No. 4,805,937 allowed to Boucher et al. While this cover is washable and foldable and protects the child from unwanted contact with the shopping cart handle, it does nothing to protect the child from the upper frame rail of the fold out child seat.

Disclosed in U.S. Pat. No. 5,722,672 allowed to Frederick in March 1998, allows for a removable protective cover attached to the shopping cart handle providing protection from the handle while including provisions for attachments, toys, and pockets for holding miscellaneous shopping and child items. Again this invention attaches to the cart handle not the upper frame rail of the fold out child seat. The proposed invention is specific to the particular metal bar of the child seat distinguishing itself from the related art.

### SUMMARY OF THE INVENTION

The primary objective of the invention is to provide a durable, sanitary protective covering for the upper frame rail of the fold out child seat commonly found in shopping carts. The invention protects babies and small children from contracting contagious diseases that may be carried by bacteria on the upper frame rail of the foldable child seat.

Another objective of the invention is to provide an easily transportable and storable system, machine washable and readily reusable cover that may be engaged over the upper frame rail of the fold out child seat.

Still another object of the invention is to provide a new and improved protective cover overcoming the disadvantages of the prior art in that the present invention addresses issue concerning the upper frame rail of the fold out child seat while prior art addressed the shopping cart handle.

The present invention is removably engagable via hook and loop connectors and constructed from washable cloth material having an inner liner of cloth padding between said hook and loop connectors providing protection from the metal bar being connected to.

One embodiment of the invention includes three pockets to hold toys, shopping lists, bottles and pacifiers.

Another embodiment of the invention includes the three pockets and has additional lanyards with hook and loop connectors that act as removably engagable securing devices preventing dropped pacifiers and bottles from contacting the unsanitary floor.

### BRIEF DESCRIPTION OF THE DRAWINGS

The invention will be described with references to the drawings, wherein:

FIG. 1 illustrates a front side view of the present invention having three pockets to hold toys, shopping lists, bottles, or pacifiers, and multiple lanyards with hook and loop connectors on the ends for securing pacifiers, bottles and the like from falling on the floor if dropped by the child;

FIG. 2 illustrates a rear view of the system having cloth backing with spaced strips of hook and loop connecting material spanning the entire width of the cloth backing;

FIG. 3 illustrates an embodiment of the present invention removably engaged to a shopping cart;

FIG. 4 illustrates the interconnection between the present invention and the upper frame rail of the cart.

### DETAILED DESCRIPTION OF PREFERRED EMBODIMENTS

The present invention is a shopping cart child seat protection, organizer, and play system. The system (10) has a first side (110) with three pockets (20,30,40), three lanyard attachments (50,60,70) for toys, bottles or other items.

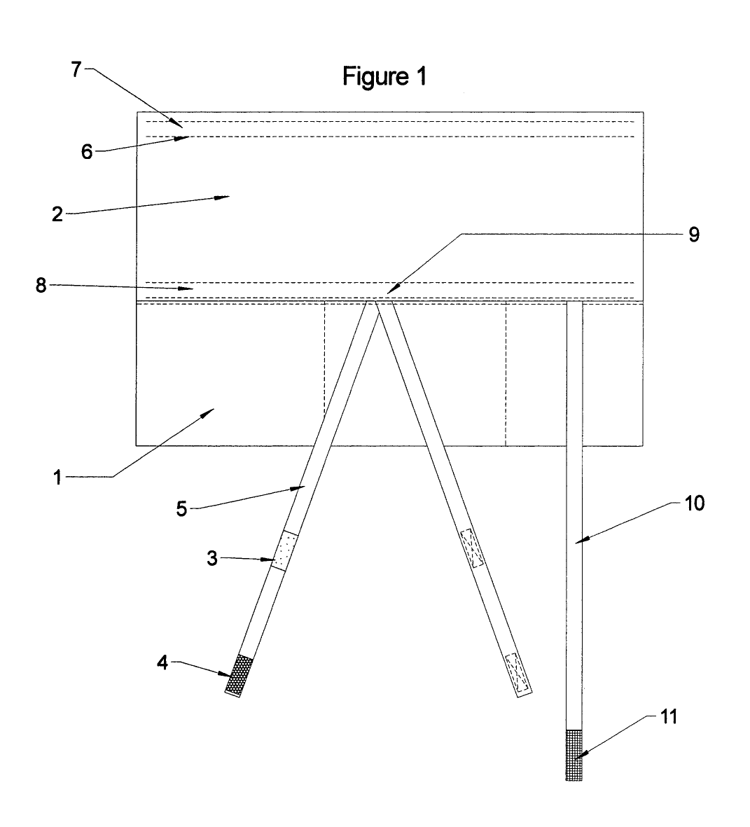

FIG. 1 shows the front side (110) of the station (10) with the first, second, and third pockets (20,30,40). The front side (110) of the system (10) also has three lanyard attachments (50,60,70). The lanyard attachments (50, 60, 70) in this embodiment have a toy (80), a pacifier (90) and a bottle (100) attached in a removably engagable manner. The lanyard attachments (50, 60, 70) keep the toy (80), pacifier (90) and the bottle (100) from falling to the floor and contacting contaminates. Also, the lanyard attachments (50, 60, 70) are long enough to allow the parent or adult to place the items (80,90,100) in the three pockets (20,30,40) for easy organization and storage.

An alternate embodiments of the present invention (10) the lanyard attachments (50, 60, 70) can be replaced by hook and loop attachments, snapping fasteners, or any other fastening means which can attach items (70,80, 90). Also the items (70, 80, 90) are not limited to a toy (70), pacifier (80), and bottle (90), but can be any applicable item that the parent or child may need. Additionally, the pockets (20, 30, 40) can hold a list, coupon book, diaper and the like to allow the parent to carry everything they need without use of an additional diaper bag.

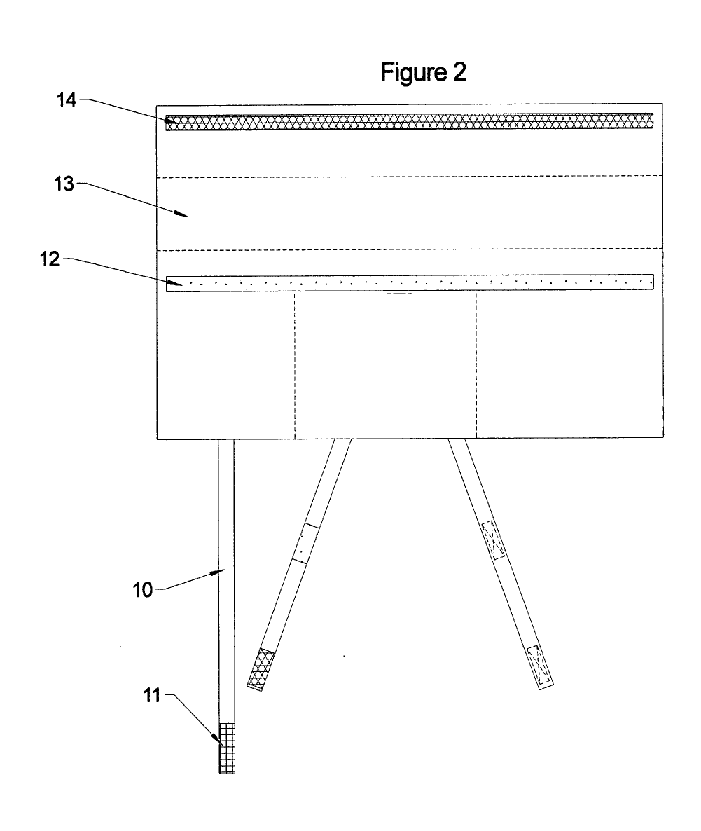

FIG. 2 illustrates a rear view of the system (20). The cloth backing (21) is shown with the hook and loop strips (22, 24) spanning the entire width of the cloth backing. The first portion (22) of the hook and loop material is placed a small distance from the edge of the cloth backing (21) of the system (20). The second portion (24) of the hook and loop material receives the first portion (22) of the hook and loop material for engagement to the upper frame rail of the fold out child seat. In the mid section between the first and second hook and loop strips (22, 24), an internal strip of additional cloth padding is added (23) to protect the child from the metal bar making up upper frame rail of the fold out child seat.

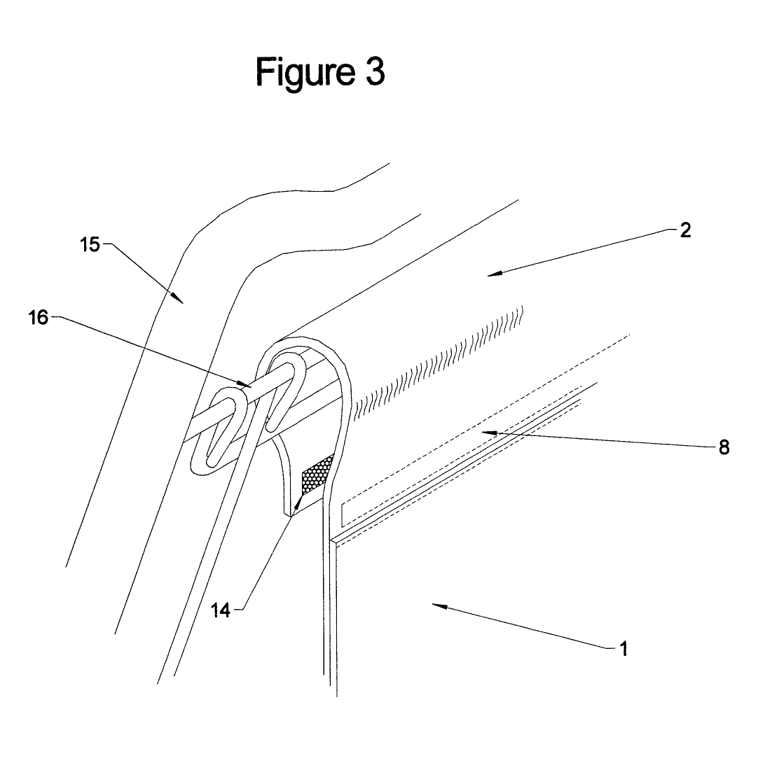

FIG. 3 demonstrates the system (30) attached to the upper frame rail of the fold out child seat.

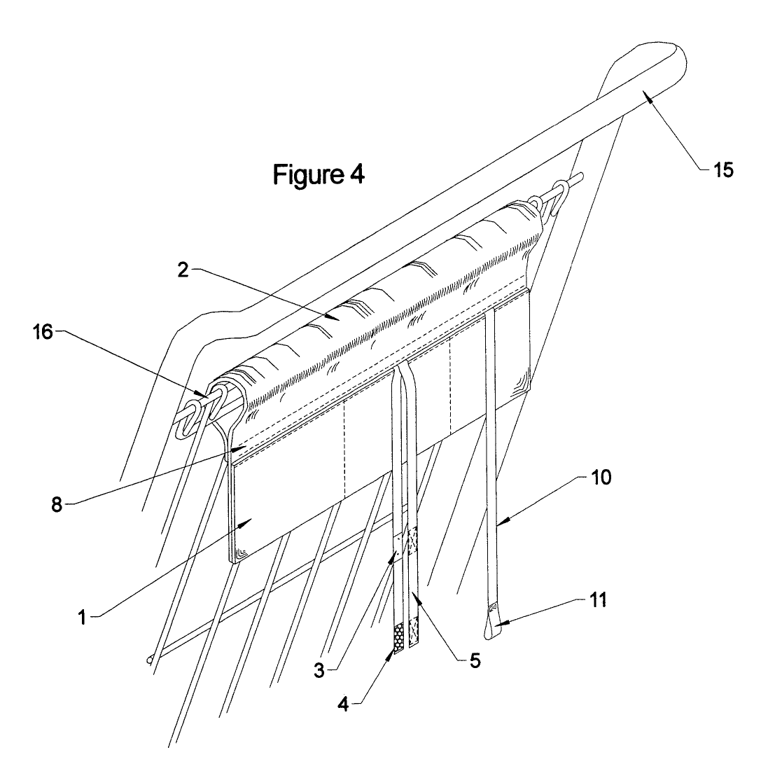

With reference now to FIG. 4, there is demonstrated common shopping cart (41) with a typical shopping cart handle (42), a fold out child seat (43), and an upper frame rail (44). The proposed invention (45) wraps around the upper frame rail (44) and securely attaches via hook and loop connectors (46). The proposed invention (46) is constructed and arranged to have additional cloth padding (47), in the portion of the cover that wraps around the upper frame rail (44). The front of the invention has pockets (48) constructed from cloth, and stitched to the front of the invention.

The invention has been described with reference to preferred embodiments thereof, which are intended to be illustrative, not limiting. Various modifications will be apparent to those of ordinary skill in the art without departing from the spirit and scope of the invention, as defined in the appended claims.

1. A washable and reusable sanitary cover that removably engages to the upper frame rail of the foldable child seat found in the common shopping cart having a top portion attaching to the upper frame rail and a bottom portion hanging downward therefrom, the cover comprising:
a rectangularly shaped cloth member having an inner surface and outer surface;
a first fastening strip of hook material attached to the top portion along the entire width of the inner surface;
a second fastening strip of loop material attached along the entire width of the inner surface, half way between the top portion and bottom portion of the rectangularly shaped cloth member;
wherein the top portion is constructed and arranged to radially wrap around the upper frame rail of the fold out child seat, removably engaging the first fastening strip with the second fastening strip on the inner surface, interlocking the hook and loop surfaces.

2. The sanitary cover according to claim 1, wherein the rectangularly shaped cloth member comprises:
a machine washable cloth external layer;
a machine washable cloth internal layer;
a medial layer of machine washable cloth padding between the external and internal layers;
wherein the external layer, interior layer, and medial layer are stitched together interlocking all three layers into one contiguous portion.

3. The sanitary cover according to claim 1, wherein the bottom portion is constructed and arranged having three cloth pockets on the outer surface.

4. The sanitary cover according to claim 1, wherein the bottom portion is constructed and arranged having multiple lanyards having hook and loop securing devices on the ends.
